(19) United States
(12) Patent Application Publication
(10) Pub. No.: US 2025/0328922 A1
(43) Pub. Date: Oct. 23, 2025

(54) SYSTEMS AND METHODS OF CONTROLLING RETAIL PRODUCT ALLOCATION AND RETAIL MARKET VARIATIONS BASED ON CUSTOMIZED INSIGHT

(71) Applicant: Walmart Apollo, LLC, Bentonville, AR (US)

(72) Inventors: Ashwini Chandrashekharaiah, Bangalore (IN); Ravishankar Balasubramanian, Bengaluru (IN); Dushyant R. Tara, Bangalore (IN); Arnabh Bhaumik, Roanoke, TX (US); Roberto Robles Nacif, Southlake, TX (US); Mohit Vijay, Branchburg, NJ (US); Denila B. Philip, Leonia, NJ (US)

(21) Appl. No.: 18/864,488

(22) PCT Filed: May 8, 2023
(86) PCT No.: PCT/US2023/021356

§ 371 Date: Nov. 8, 2024

Related U.S. Application Data
(60) Provisional application No. 63/340,198, filed on May 10, 2022.

(51) Int. Cl. G06Q 30/0201; G06N 5/022; G06Q 10/08

(52) U.S. Cl. CPC G06Q 30/0201; G06N 5/022; G06Q 10/08

(57) ABSTRACT

Some embodiments provide systems to control customized retail product performance information, comprising: a linkage mapping system to define and update linkings within a knowledge graph; a personalization recommendation system controlling different display systems to control graphical user interfaces presenting customized anomaly notification information specific to intended recipients as a function of the linkings; and a community detection system applying a set of machine learning community detection models to identify additional relationships between two or more of the entity nodes, based on feedback data from multiple intended recipients, and cause the linkage mapping system to update the multi-level linkages to embed one or more additional association links between the two or more of the entity nodes; wherein the personalization recommendation system is configured to control, based on the updated additional association links, a first graphical user interface to present first customized anomaly notification information specific to a first intended recipient.

### CROSS-REFERENCE TO RELATED APPLICATIONS

This application claims the benefit of U.S. Provisional Application No. 63/340,198 filed May 10, 2022, which is incorporated herein by reference in its entirety.

### TECHNICAL FIELD

This invention relates generally to controlling product distribution.

### BACKGROUND

Retail sales of products typically vary dramatically over time. It is common to evaluate sales over time in attempts to identify how a product is performing. However, it would be beneficial to further improve the management of retail products.

### BRIEF DESCRIPTION OF THE DRAWINGS

Disclosed herein are embodiments of systems, apparatuses and methods pertaining to controlling product distribution. This description includes drawings, wherein:

FIG. 1 illustrates a simplified block diagram of a retail product allocation control system, in accordance with some embodiments.

FIG. 2 illustrates a simplified, two-dimensional representation of a portion of an exemplary knowledge graph, in accordance with some embodiments.

FIG. 3 illustrates a simplified representation of an example of customized anomaly notification information configured to be displayed through a graphical user interface of one or more recipient computing devices, in accordance with some embodiments.

FIG. 4 illustrates a simplified flow diagram of an exemplary process of controlling customized retail product performance information presented to respective individuals, in accordance with some embodiments.

FIG. 5 illustrates a simplified block diagram of an exemplary process of reinforcing settings and/or links of entity nodes, in accordance with some embodiments.

FIG. 6 shows a simplified block diagram functional representation of the retail product allocation control system illustrating different functional aspects of the retail product allocation control system and the interoperability of the functional aspects, in accordance with some embodiments.

FIG. 7 shows a functional representation of the knowledge graph system illustrating different functional aspects of the knowledge graph system and the interoperability of the functional aspects, in accordance with some embodiments.

FIG. 8 shows a functional representation of the alert and attribution personalization system illustrating different functional aspects of the alert and attribution personalization system and the interoperability of the functional aspects, in accordance with some embodiments.

FIG. 9 illustrates an exemplary updating of links within an exemplary knowledge graph in accordance with some embodiments.

FIG. 10 illustrates an exemplary representation of updating of links within the knowledge graph based on searching, in accordance with some embodiments.

FIG. 11 illustrates an exemplary representation of updating of links within the knowledge graph based on feedback, in accordance with some embodiments.

FIG. 12 illustrates an exemplary system for use in implementing methods, techniques, devices, apparatuses, systems, servers, sources in enhancing knowledge graphs and control of product distribution, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

The present embodiments provide machine learning based systems and methods that improve control over product management through the simplified and enhanced processing of a variety of different information from a multitude of sources. Further, the systems and methods utilize machine learning models to enhance the control over information provided to intended recipients in order to provide personalized information that is more relevant to the intended recipient and/or more relevant to the supervision the intended recipient performs in controlling management of product distribution, product placement, product pricing, product marketing, and/or other such aspects of product management over retail products. Still further, the application of the sets of machine learning models greatly reduced computational processing in improving the access to relevant information, while further significantly reducing computation overhead and memory storage needed.

Retail, consumer packaged goods (CPG) and other related companies have many product and business functions that affect and/or are responsible for driving business targets and goals to drive sales, revenues and/or profits. Typically, these business and product functions are represented by different groups or user personas (e.g., merchants, sales managers, account managers, product category advisers, replenishment managers, supply chain planners, market researchers, and other such types of personas each with defined functional responsibilities). The key performance indicators (KPI) and/or metrics that these user personas consider and/or consume are as varied as business metrics (e.g., sales and volume, supply chain metrics such as inventory-at-hand, lead times, fill-rates, market metrics such as customer trends and regional/local preferences, market share metrics, and other such metrics).

For example, because of supply chain challenges, inventory for a specific category of products (e.g., cold beverages from a particular supplier) is low. This problem has different considerations for different personas. A supply chain planner (user persona) is likely primarily concerned with solving for supply versus demand. A category adviser (user persona) may be interpreting that this category of products are selling less, and accordingly may be planning to discontinue one or more products or plan promotions, even though the low sales is caused by the inventory issues and not lack of demand. A market researcher (user persona) may be wondering why sales of products of this category are lagging when customers are not purchasing the products (e.g., as a result of there being a lead time to restock, the customer may have moved to a different brand). Accordingly, different types or personas of recipients of information associated with evaluating product performance have different considerations, different factors to consider, different reaction times, and/or other such differences.

The present embodiments, however, enhance the control of product distribution in part through the identification of relevant information. Some embodiments identify and/or control the presentation of customized retail product performance information as a function of the user persona with which each intended recipient is associated. Further, some embodiments create and continuously update through the application of multiple sets of machine learning models one or more retail knowledge graphs that define and/or establish representative links or connections between users, collaborators, products, metrics, insights, attributions and other such associations. One or more of the knowledge graphs, along with identifications of recipient/user communities or subgroups and user feedback, can be used by present embodiments to generate the personalized insights recommendations. The personalized insights enables the connection of an intended recipient to their most relevant metric with suitable attributions that are actionable by them in order to identify the information that is most relevant to that group or individual in presenting the customized information particular to that group or individual.

Generally speaking, pursuant to various embodiments, systems, apparatuses and methods are provided herein to control retail product allocation and control customized retail product performance information presented to respective individuals. In some embodiments, systems comprise a linkage mapping system, a personalization recommendation system and/or application, and a community detection system. Further, some embodiments include a similarity evaluation system and a similarity weighting system. The linkage mapping system, in part, is configured to define and update multi-level linkings between entity nodes, which in some embodiments are part of a knowledge graph utilized to identify correlations and more relevant information. Further, the linkage mapping system continuously evaluates correlations, feedback information and/or other information in establishing, maintaining and continuously updating embedded links between nodes to enhance the correlation between nodes and improve the identification of more relevant information to particular types or groups of intended recipient and/or specific intended recipients. The entity nodes comprise product source nodes associated with each of multiple different product sources providing products to one or more retailers and/or retail stores, distribution centers, fulfillment centers, etc., recipient nodes each associated with one of multiple intended recipient users that are each associated with a respective one of the product sources, product nodes each associated with a different retail product supplied to the one or more retailers, and anomaly alert nodes each associated with an alert corresponding to a category of products relative to business metrics, such as sales data.

In some embodiments, the personalization recommendation system is configured to generate information used by receiving recipient computing devices to control respective different display systems to control respective graphical user interfaces presenting different customized anomaly notification information specific to respective intended recipients of numerous different intended recipients as a function of the linkings associated with the respective intended recipient. The community detection system, in some implementations, applies a set of machine learning community detection models to identify, based on feedback data from multiple intended recipients of the numerous different intended recipients each relative to one of the presented different customized anomaly notification information, additional relationships between two or more of the entity nodes, and cause the linkage mapping system to update the multi-level linkages to embed one or more additional association links between the two or more of the entity nodes based on the identified additional relationships. In some embodiments, the personalization recommendation system is configured to control, based on the updated additional association links, a first graphical user interface to present first customized anomaly notification information specific to a first intended recipient, of the numerous different intended recipients, associated with a first recipient entity node of the two or more entity nodes based on a first additional association link, of the updated additional association links, of the first recipient entity node.

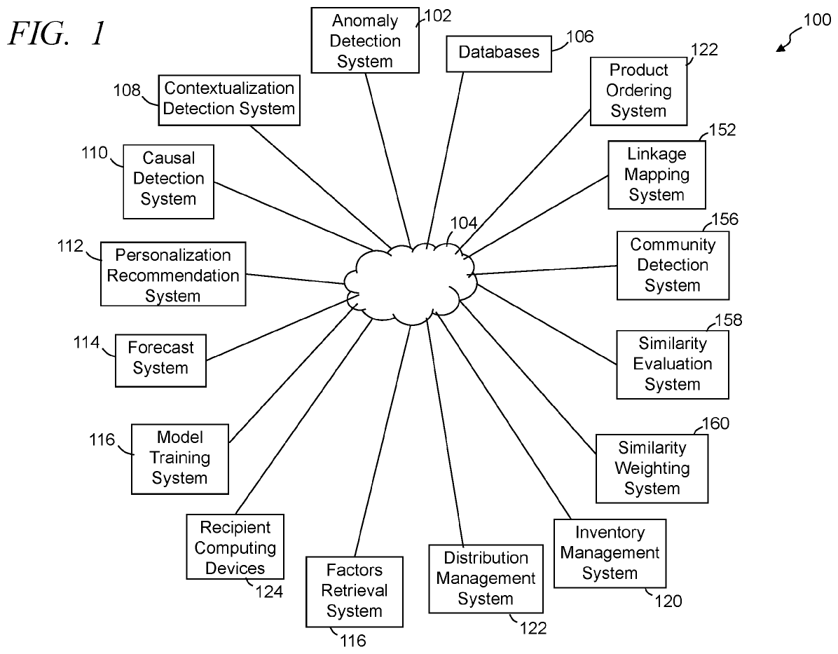

FIG. 1 illustrates a simplified block diagram of a retail product allocation control system 100, in accordance with some embodiments. The product allocation control system 100, in some implementations, is configured to control customize retail product performance information, the distribution of such information, and the management of associations between different entities associated with and/or affecting business metrics, such as but not limited to product sales performance, product inventory, product distribution, product marketing and/or other such information. The product allocation control system 100 includes an anomaly detection system 102 that is communicatively coupled over one or more distributed computer and/or communication networks 104 with one or more databases 106 (e.g., inventory database, historic anomaly information database, purchase history database, recipient database, customer database, customer profile database, supplier information database, training data database, machine learning model database, knowledge graph database, and the like) and/or other relevant computer memory systems. The communication networks can be substantially any relevant communication network, such as but not limited to cellular communication network(s), the Internet, local area network(s) (LAN), wide area network(s) (WAN), Wi-Fi network(s), Bluetooth network, other such wired and/or wireless networks, or a combination of two or more of such networks.

The product allocation control system 100 further includes a personalization recommendation system 112, a linkage mapping system 152, and a community detection system 156. Further, the product allocation control system 100 typically includes a similarity evaluation system 158 and a similarity weighting system 160.

Additionally, the product allocation control system 100 includes one or more machine learning model training systems 116 that is communicatively coupled with at least a model database and one or more training data databases. The system optionally further includes one or more of a contextualization detection system 108, a causal detection system 110, and a forecast system 114.

Some embodiments further include and/or is typically in communication with one or more inventory management systems 120 that track retail product inventory associated with one or more retailers, one or more retail facilities, one or more retail sales channels and/or other such inventory information, and/or manages the communication of product allocation instructions in directing the transfer of products. Some embodiments include and/or are in communication with one or more product distribution management systems 122 that manage the distribution of products to and from retail facilities (e.g., warehouses, fulfillment centers, retail stores, etc.), along sales channels and/or to customers. The product allocation control system 100 is further in communication with and/or includes numerous different recipient computing devices 124. Typically, each of the recipient computing devices 124 is associated with a respective one of a product supplier, a retailer, a shipping service, or other such entity that is expected to request access to information to improve control of product allocation and/or distribution. The recipient computing devices 124 can include fixed computing devices (e.g., computers, servers, etc.) and/or mobile computing devices (e.g., laptops, tablets, smartphones, other such computing devices, or a combination of two or more of such devices).

As introduced above, the systems and methods enhance the identification of different information that is more relevant to respective different users through the application of sets of highly trained machine learning models. Through the application of these models relative to associations between entity nodes of one or more knowledge graphs, historic information, recent product information (e.g., sales, shipping, inventory, demand, etc.), other such information, and typically a combination of two or more of such information. Further, the systems and methods are configured to continuously evaluate one or more of such information in relation to feedback information to continuously manage and update over time the associative links between entity nodes within the one or more knowledge graphs. The enhanced identification of new and/or changing levels of association between entity nodes greatly reduces the computational processing in identifying more relevant information for groups of intended recipients and/or a specific intended recipient. Again, different user personas are going to be interested in different information in order to make decisions relative to their respective responsibilities/tasks associated with one or more retail facilities, sales, supply chains and/or other aspects of product performance and/or business metrics. By continuously updating link associations between different node entities, the systems and methods are better able to provide more relevant and up to date information relative to a type of intended recipient and/or a specific intended recipient.

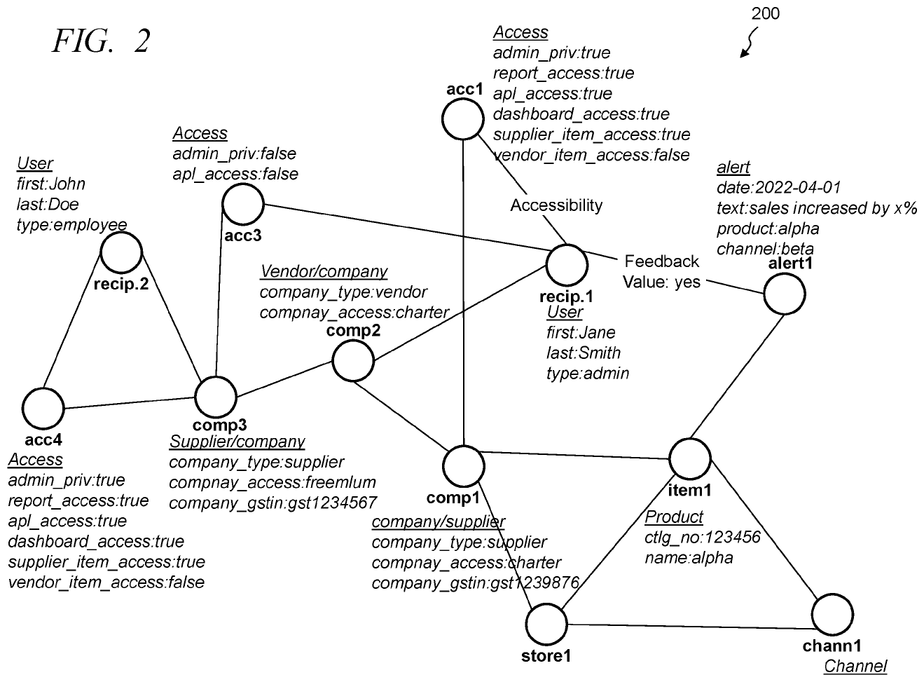

FIG. 2 illustrates a simplified, two-dimensional representation of a portion of an exemplary knowledge graph 200 or other association linking database or structure, in accordance with some embodiments. In this exemplary illustration, multiple entity nodes 202 are represented, and the entity nodes are linked to one or more other entity nodes. The links (sometimes referred to herein as a linkage, edges, or correlation) represent an association within the data structure of the knowledge graph between two or more entity nodes (e.g., recipient user nodes, access nodes, company nodes, store nodes, product nodes, retail channel nodes, alert nodes, and/or other such nodes). The knowledge graph provides a flexible framework to accommodate future needs for expansion. Further, some embodiments incorporate node information and/or otherwise associate node information relative to one or more of the nodes. As an example, a recipient belongs to a company and the company is linked to multiple products (products typically have hierarchy mappings). Against each product or product hierarchy, alerts generated are mapped and correspondingly the attribution factors for the alerts. Based on the attributes of the alerts and attribution factors, and the recipient's touchpoints and/or other feedbacks the embeddings in the knowledge graph are updated through active learning.

The linkage mapping system 152 defines, recommends and/or updates multi-level association linkings between entity nodes within one or more knowledge graphs and/or other such association databases. The entity nodes can represent product sources, intended recipients of product information from the system, one or more retailers, products or items, alerts, metrics, attributes, and other such entities. For example, some embodiments include product source nodes each associated with one of multiple different product sources (e.g., product manufacturer, product supplier, product shipper, etc.) providing products to one or more retailers, recipient nodes each associated with one of multiple intended recipient users or group of users that are each associated with a respective one of the product sources, product nodes each associated with a different retail product supplied to the one or more retailers, anomaly alert nodes each associated with an alert corresponding to a category of products relative to one or more business metrics (e.g., sales data), and other such nodes defined with link associations, such as in one or more knowledge graphs.

The personalization recommendation system 112 is configured to identify specific anomaly information that is of particular relevance to a particular intended recipient. Using this identified customized information, the personalization recommendation system is further configured to communicate information and/or instructions to control different display systems of different intended recipient computing devices 124 in controlling respective graphical user interfaces (GUI) rendered through the display systems of the recipient computing devices 124 to present different customized anomaly notification information specific to the respective intended recipients as a function of the linkings with the respective recipient node associated to the intended recipient.

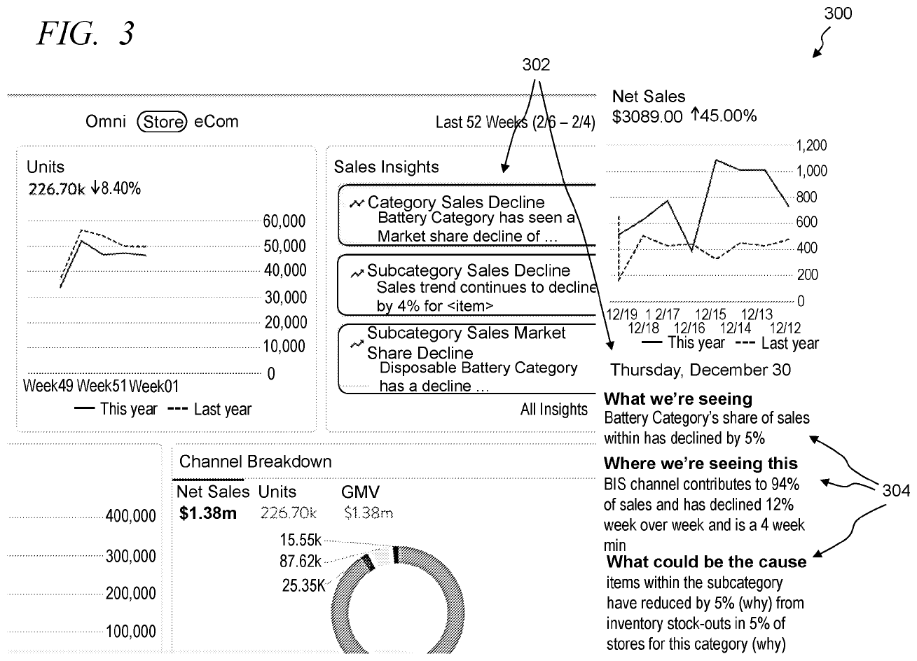

FIG. 3 illustrates a simplified representation of an example of customized anomaly notification information 300 configured to be displayed through a graphical user interface of one or more recipient computing devices 124, in accordance with some embodiments. As described above and further below, the customized anomaly notification information includes various types of information identified as being of particular relevance to the receiving recipient. A graphical user interface (GUI) is controlled to present the customized anomaly notification information based on information determined to be most relevant to a particular intended recipient, in accordance with some embodiments. In some embodiments, the GUI enables the recipient to interact with the information, obtain more details for particular portions of the information, and collaborate with other potential recipients (e.g., tagging one or more portions of the information, indicating a preference or dislike for certain types of information, adding comments, searching for information, and/or other such interactions). Such interactions provide feedback to the system that is used by machine learning models in recommending links between entity nodes, and/or updating and maintaining the knowledge graph to enhance the association between entity nodes, which in part enables more reliable information provided to different intended recipients.

One or more collaboration area 302 or space are provided that enable provide some of the relevant information (e.g., alerts, attributions for alerts, etc.) and, in some embodiments includes interactive functionalities that enable the recipient to interact with the information and/or graphical user interface through one or more clickstream functions (e.g., views, selection of one or more options, accessing other information, etc.), collaborations (e.g., thumbs up or down, predefined choices, text feedback, rating, tagging, etc.) and the like. Further, in some embodiments, the customized anomaly notification information includes one or more textual summaries 304 further textually explaining alerts, their causes, forecasted deviation between forecasted trends of one or more business metrics for one or more products of a category of products relative to the intended goal, and/or other such information.

In some embodiments, the community detection system 156 applies a set of one or more machine learning community detection models to identify relationships and/or additional relationships between recipient-recipient, recipient-metric, recipient-product, company-product, product-product, product-alert, alert-attribute, and the like, represented by the entity nodes, based on feedback data from multiple intended recipients of the numerous different intended recipients each relative to one of the presented different customized anomaly notification information. For example, the feedback can include information received through the recipient computing devices 124 as the recipient considers the information and/or accesses other related data, initiates and/or communications regarding the anomaly notification information and/or other information, searching for information, marking and/or highlighting information, copying information, selecting parts of the information, and/or other such interactions. In some embodiments, for example, the feedback information can include clickstream information, views, frequency, alert description views, drill-downs, touchpoints, likes/dislikes, user attributes, collaboration, pointers through user rules, searches, chatbot conversations, A/B testing responses, alert ratings, alert feedback, attribution feedback, user tags, searches, other such feedback, and typically a combination of two or more of such feedback. As one example, the community detection system 156 in applying the community detection models is configured to evaluate touch points by each of the multiple intended recipients in considering the respective customized anomaly notification information, and identify associations between two or more of the multiple intended recipients as a function of correlations between respective touch points. Similarly, in some embodiments, the feedback is obtained through a graphical user interface by an associated intended recipient. The feedback can include a tagging by the intended recipient to direct to another intended recipient at least a portion of the customized anomaly notification information. The portion of the customized anomaly notification information corresponds to an alert entity node that is associated with a second recipient entity node that corresponds to the other intended recipient.

In evaluating the feedback relative to the links between entity nodes, the set of community detection models in some embodiments identify and associate recipients through their entity nodes into sub-groups or communities of two or more recipients, which might otherwise not be associated, that are predicted to have similar or substantially the same goals, KPIs and/or responsibilities and expected to be interested in similar or substantially the same information and with certain types of information, attributes, preferences and the like being relevant to each recipient in the sub-group. The groupings can be used in identifying linkages that might be added, adjusted, removed and the like based on the correlation between members of the sub-group and the feedback. Some embodiments, for example, utilize hierarchical divisive community detection methods in identifying recipient communities identifying strong and weak linkages and/or adjusting linkages, utilize Louvain community detection and/or deep walk with Gaussian mixture model (GMM) based community detection in identifying alert and attribution linkages, and/or other such models relative to the feedback and existing linkages. These sub-groups can be associated as sub-graphs within the knowledge graph, and sub-groups can overlap with multiple sub-groups. Further, sub-groups can be established at multiple different dimensions within the knowledge graph. In some embodiments, smaller sub-graphs are carved on the recipient dimension based on recipient similarity, user attributes and user usage metrics. Sub-graphs of alert metrics can be grouped based on their attributes and the feedback. Other such sub-graphs can be established based on the identified correlation as a function of the feedback received. The sub-graphs are not typically limited to recipients associated with the same company, but instead can extend across multiple companies with certain types of information, attributes, preferences and the like being relevant to both potential recipients. The models identify over time the sub-groups and based on the sub-groups what a first recipient views and/or accesses may be identified as relevant to the other users within a respective sub-group corresponding to the information being considered. For example, alters and/or trends of alerts based on usage by one user influences other users of a sub-group and the information they receive. Sub-groups can be established and/or modified in part based on, for example, click-habits, alert views, alert tags, comments, and other such feedback. Similarly, sub-graphs or sub-groups can be established between other types of entity nodes, such as alerts, attributions, attribution domains, and/or other nodes (e.g., based on kinds of alerts, how metrics are related, strength of linkage, etc.).

The community detection system 156 can apply one or more of the set of community detection models based on, for example, a tagging in identifying the additional relationships between two or more of the entity nodes, and in updating the linkages cause the linkage mapping system 152 to update the multi-level linkages to increase a level, degree, strength or the like of an association of a recipient-recipient link between a first recipient entity node associated with the intended recipient and a second recipient entity node associated with the other intended recipient. A recipient-alert link can be embedded into the knowledge graph between the second recipient entity node and the alert entity node. Additionally or alternatively, in some embodiments a level of association of alert-attribute links between the alert entity node and a set of attribute nodes previously associated with the alert entity node can be increased, strengthened or otherwise defined with a higher priority. Further, based on the additional relationships, the community detection system can cause the linkage mapping system 152 to update the multi-level linkages to embed one or more additional association links between the two or more of the entity nodes based on the identified additional relationships. Similarly, in some embodiments, the community detection system 156, in applying the set of machine learning community detection models, further causes updating of the linkages based on a search through the graphical user interface by the intended recipient as feedback in response to identifications of links between nodes associated with the search criteria.

The personalization recommendation system 112 is configured to identify specific content associated with a particular intended recipient or type of recipients, based on the updated additional association links, and control, based on the updated additional association links, a graphical user interface of a user computing device associated with the particular intended recipient to present and/or recommend a customized anomaly notification information specific to the particular intended recipient associated with a recipient entity node of the two or more entity nodes based on an additional association link, of the updated additional association links, of the recipient entity node.

Some embodiments further evaluate links between entity nodes in relation to feedback to identify correlations or similarities that can be applied in association with other entity nodes. In some embodiments, the community detection system 156, in applying the set of community detection models, is further configured to recommend embeddings, such as a recipient-alert link, recipient-product link, product-alert link, or other such linking. As one non-limiting example, the community detection system 156 may recommend embedding a recipient-alert link between a second recipient entity node and an alert entity node based on a strength of a level of association of a recipient-recipient link between a first recipient entity node and the second recipient entity node and a strength of a level of association of a recipient-alert link between the first recipient entity node and the alert entity node. Similarly, in some embodiments this evaluation and enhanced linking may be initiated in response to the creation of a link and/or a modification of a level of association in one or more links associated with one or both of the two recipients (e.g., in response to a modification of a recipient-recipient link between the first recipient and the second recipient). For example, the community detection system may recommend embedding a recipient-alert link between the second recipient entity node and an alert entity node in response to the increasing of the level of association of a recipient-recipient link between the first recipient entity node and the second recipient entity node, and based on a strength of a level of association of the first recipient-recipient link between the first recipient entity node and the second recipient entity node and a strength of a level of association of a recipient-alert link between the first recipient entity node and the alert entity node.

Some embodiments include the similarity evaluation system 158 that applies a set of one or more trained machine learning similarity models to pluralities of different recipient-alert links between different sets of recipient entity nodes and alert entity nodes in relation to feedback, such as but not limited to interaction by the first intended recipient with the first customized anomaly notification information, and identify relative similarity measures associated with each of the respective recipient entity node and the respective alert entity node in predicting potential additional linkages to associate with multiple other recipient entity nodes. Similarities can be used to recommend and/or establish further embeddings between nodes, enhance strength of a link, reduce strength of a link and the like. Accordingly, the knowledge graph can be enhanced over time in response to the feedback and identified similarities.

The linkages are utilized, in some embodiments, in cooperation with a matrix factorization based recommendation engine to add value to the weights of how strongly entity nodes are linked. Some embodiments utilizes the knowledge graph as an enhancement to collaborative filtering and factorization based recommendation engines. The similarity evaluation system in applying the set of similarity models can focus factorization and filtering of associations between entity nodes as a function of the embedded links between respective pairs of entity nodes. In some embodiments, the similarity evaluation system 158 apply hybrid models to obtain link predictions used as implicit feedback into collaborative filtering settings, and linkages provide additional measures into a matrix factorization based recommendation engine.

Further, some embodiments include a similarity weighting system 160. The similarity weighting system 160 is configured to apply a set of trained machine learning weighting models relative to the similarity measures based on the feedback continuing to be received over time from the multiple intended recipient users to repeatedly modify weightings to identified similarity measures in selecting appropriate similarity measures relative to a particular one of the multiple intended recipient users in predicting the potential additional linkages to associate with the particular one of the multiple other recipient entity nodes. Additionally or alternatively, the similarity weighting system 160 in applying the set of trained machine learning weighting models identifies group similarity measures between entity nodes within an identified sub-graph or sub-group to improve the precision of the knowledge graph, enhances the correlation and identification of relevant information, and increases diversity within the knowledge graph.

Additionally, some embodiments enhance the linking when adding new recipient node and auto-linking based on a linking of related or similar recipient. In some embodiments, the linkage mapping system 152 is configured to add a new recipient node in response to a new intended recipient being associated to receive personalized anomaly notification information. The addition of a new recipient entity node, however, has limited linkage within the knowledge graph. Accordingly, in some embodiments, the community detection system 156, in applying one or more of the set of community detection models, is configured to identify that the new intended recipient has a threshold relationship with another intended recipient associated with an existing recipient entity node. The threshold relationships are not limited to being in the same company, and instead extend to types of responsibilities, KPIs, expected information interests, expressed preferences and/or settings, other such factors, and typically a combination of two or more of such factors. For example, it may be identified that a previously existing first recipient entity node associated with a first recipient has a threshold relationship with the newly added entity node. In response to adding the new recipient node and based on the identification of the threshold relationship with the other intended recipient, the linkage mapping system 152 can update and/or be directed to update the multi-level linkages to embed multiple initial association links corresponding to a set of association links between the existing recipient entity node and two or more other recipient entity nodes with which the existing recipient entity node is already linked. With the enhanced initial linkages of the new recipient entity node the personalization recommendation system 112 is able to immediately direct more relevant information to the new recipient controls instead of solely relying on feedback over time. As such, based on the initial association links, the personalization recommendation system 112 can cause a graphical user interface at the new recipient's computing device to present customized anomaly notification information specific to the new intended recipient associated with the new recipient entity node as a function of the enhanced initial association links that is more relevant than otherwise would be provided.

The one or more machine learning model training systems 116 are communicatively coupled with at least one model database maintaining trained models and one or more training data databases that stores relevant training data to train and/or retrain the community detection models, similarity models, weighting models and/or other relevant models. The training data database stores and updates relevant training data. The training data includes historic data of recipients and their association with known companies, predefined profiles of types of recipients, predefined profiles of known preferences of information, predefined associations of responsibilities to types of recipients and other such information. Further, the training data includes historic business metric data, such as sales data (e.g., quantities of products sold, pricing, pricing adjustments, etc.), typically for one or more years, in association with historic inventory information, historic marketing information, and other such information. Some embodiments further include historic anomaly detected events in relation to known historic causes of those historic anomaly events. The training data additionally includes historic information about different information supplied to and/or accessed by different users corresponding to thousands or more products from hundreds of different suppliers and/or manufactures and sold from multiple different retail stores distributed over multiple different geographic areas. Further, the training systems 116 is configured to receive feedback information at least through the graphical user interface corresponding to actions by the different recipients interfacing with the respective graphical user interface based on the rendered customized anomaly notification information. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system 116 utilizes the feedback information to repeatedly over time retrain the community detection models, similarity models, weighting models and/or other relevant models to repeatedly provide over time retrained community detection models, similarity models, weighting models and/or other relevant models that improve performance over time and enhance the association between entities through the improved linkages between the associated entity nodes.

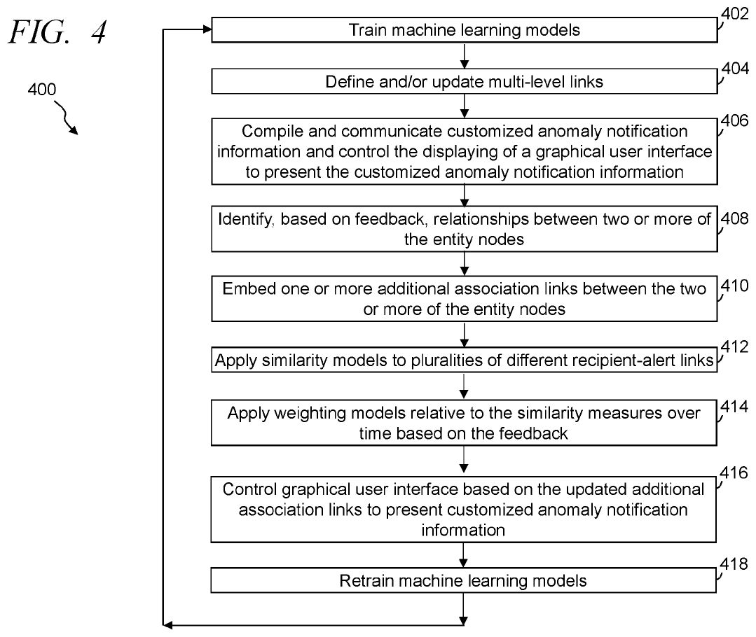

FIG. 4 illustrates a simplified flow diagram of an exemplary process 400 of controlling customized retail product performance information presented to respective individuals, in accordance with some embodiments. In step 402, community detection models, similarity models, weighting models and/or other relevant machine learning models and/or learning algorithms are trained using corresponding training data accessed from one or more training model databases and/or other such sources. As described above and further below, the training data can include historic sales data over one or more known periods of time, historic inventory data over one or more known periods of time, predefined known data that indicates known anomalies, other business metric data, known association data identifying known associations between types of information, recipients, alerts, attributes, and the like, predefined product data, other such information, and typically a combination of two or more of such information.

In step 404, multi-level linkings within a knowledge graph between entity nodes within a knowledge graph are defined and updated. As described above, some of these entity nodes include product source nodes associated with each of multiple different product sources providing products to one or more retailers, recipient nodes each associated with one of multiple intended recipient users that are each associated with a respective one of the product sources, product nodes each associated with a different retail product supplied to the one or more retailers, and anomaly alert nodes each associated with an alert corresponding to a category of products relative to one or more business metrics.

In step 406, different display systems of recipient computing devices 124 are controlled to control respective graphical user interfaces presenting different customized anomaly notification information specific to respective intended recipients of numerous different intended recipients as a function of the linkings associated with the respective intended recipient. In step 408, a set of machine learning community detection models are applied to identify, based on feedback data from multiple intended recipients of the numerous different intended recipients each relative to one of the presented different customized anomaly notification information, additional relationships between two or more of the entity nodes and/or modifications to relationships between two or more entity nodes. These modifications can include but are not limited to embedding new linkings, assigning and/or adjusting a level of association for a respective link, removing a link, adding new entity nodes and assigning links to the new entity nodes, removing nodes and removing corresponding linkings, incorporating a relevance to a link, other such modifications to one or more of the linkings, or a combination of such modifications.

Some embodiments include step 410 where the community detection system 156 causes the linkage mapping system 152 to update the multi-level linkages, for example, to embed one or more additional association links between the two or more of the entity nodes based on the identified additional relationships, adjust a level of association for a respective link, remove a link, add new entity nodes and assign links to the new entity nodes, remove one or more nodes and remove corresponding linkings, other such modifications to one or more of the linkings, or a combination of such modifications.

The process 400, in some embodiments, includes step 412 where a set of machine learning similarity models are applied relative to pluralities of different recipient-alert links between different sets of recipient entity nodes and alert entity nodes in relation to the feedback that can include interactions by a first intended recipient with the respective customized anomaly notification information. Relative similarity measures are identified that are associated with each of the respective recipient entity node and the respective alert entity node in predicting potential additional linkages to associate with multiple other recipient entity nodes. In some embodiments, the application of the set of similarity models focuses factorization and filtering of associations between entity nodes as a function of the embedded links between respective pairs of entity nodes. Some embodiments include step 414 where a set of one or more machine learning weighting models are applied relative to the similarity measures over time based on the feedback continuing to be received over time from the multiple intended recipient users, and repeatedly modify weightings to identified similarity measures in selecting appropriate similarity measures relative to a particular one of the multiple intended recipient users in predicting the potential additional linkages to associate with the particular one of the multiple other recipient entity nodes.

In step 416, a graphical user interface is controlled, based on the updated additional association links, to present the customized anomaly notification information specific to a particular intended recipient, of the numerous different intended recipients, associated with a particular recipient entity node of the two or more entity nodes based on an additional association link, of the updated additional association links, of the recipient entity node. The process 400 further includes step 418 where one or more of the community detection models, similarity models, weighting models and/or other relevant machine learning models and/or learning algorithms are retrained based on the known information, updated information obtained over time, the feedback received over time, and other such relevant information. It is noted that step 418 can be implemented at substantially any time in the process. Some or all of one or more of the steps of the process 400 can be repeated over time. In some embodiments, for example, one or more of steps 402, 408, 412, 414 and/or 418 can be repeated one or more times utilizing new and/or additional information (e.g., new recipient, new product, updated product information, removal of a recipient, removal of a product, etc.), feedback received over time, and/or other such information to continue to make recommendations, add link embeddings, update a strength of the link (increase or decrease), add entity nodes, update nodes, delete links, remove nodes, and/or other such updating to the one or more knowledge graphs. Similarly, the process 400 is frequently and/or continuously repeated over time. The frequency can be dependent on one or more factors, such as but not limited to the recipient feedback, product information, supplier information, alerts, frequency of alerts, one or more schedules, and/or other such factors and/or information.

In some embodiments, the feedback includes one or more touch points by each of the multiple intended recipients in considering the respective customized anomaly notification information. Step 406, in some embodiments, includes evaluating one or more of the touch points, based on the application of the community detection models, and associations are identified between two or more of the multiple intended recipients as a function of correlations between respective touch points. The feedback, in some embodiments, can include a tagging. For example, tagging feedback can be obtained through a graphical user interface by the intended recipient. The tagging can, for example, intend to direct to a second intended recipient a portion of the customized anomaly notification information corresponding to an alert entity node that is associated with a second recipient entity node corresponding to the second intended recipient. One or more of the set of community detection models can be applied based on the tagging to identify the additional relationships. Based on the identified relationship, the multi-level linkages can be updated to adjust (e.g., increase, decrease, null, remove, add, etc.) a level of association of a first recipient-recipient link between a first recipient entity node associated with the first intended recipient and a second recipient entity node associated with the second intended recipient. Additionally or alternatively, a first recipient-alert link between the second recipient entity node and the first alert entity node is embedded, and a level of association of alert-attribute links between the first alert entity node and a set of attribute nodes previously associated with the first alert entity node can be adjusted (e.g., increased, decreased, one or more removed, etc.).

Further, in some embodiments, embedding of a recipient-alert link is recommended, based on the application of the set of community detection models, between the second recipient entity node and a second alert entity node based on a strength of a level of association of the first recipient-recipient link between the first recipient entity node and the second recipient entity node as a function of the increasing of the level of association of the first recipient-recipient link between the first recipient entity node and the second recipient entity node, and/or based on a strength of a level of association of a second recipient-alert link between the first recipient entity node and the second alert entity node. Additionally or alternatively, in some implementations the feedback includes a searching by the recipient through the graphical user interface. In applying the set of community detection models relative to the search feedback, some embodiments cause an updating of the linkages based on the search by the first intended recipient as feedback in response to identifications of links between nodes associated with the search criteria.

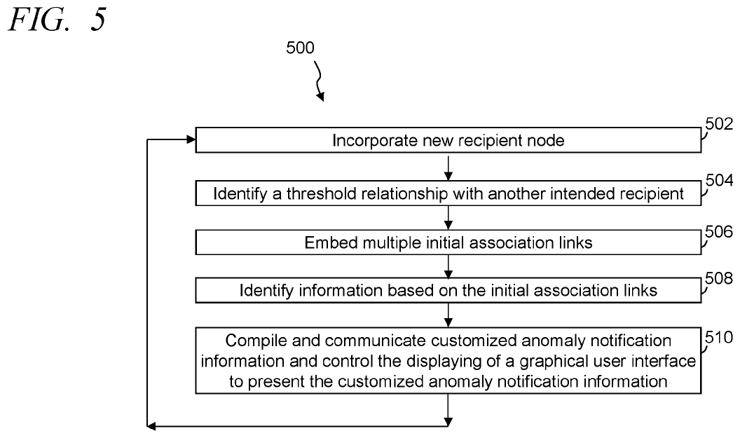

The system further provides a reinforcement setup of new alerts, users, products and the like that are to be associated with new entity nodes and/or existing entity nodes to aid in overcoming a cold start problem and continuously enhancing the associations between entity nodes. FIG. 5 illustrates a simplified block diagram of an exemplary process 500 of reinforcing settings and/or links of entity nodes, in accordance with some embodiments. In step 502, a new recipient node is incorporated into the knowledge graph in response to a new intended recipient being identified to receive information. In step 504, it is identified that the new intended recipient has a threshold relationship with another intended recipient that is already associated with an existing entity node. For example, the new intended recipient may have the same or a similar job title, may be associated with the same company with which the existing recipient is associated, the new recipient is to receive a particular alert, other such indications, or a combination of two or more of such indications.

In step 506, the multi-level linkages are updated, in response to adding the new recipient node and the identification of the threshold relationship with the other intended recipient, to embed multiple initial association links corresponding to a set of association links already established between the recipient entity node associated with the other recipient and two or more other entity nodes. In step 508, information is identified based on the initial association links that is to be communicated to the new intended recipient, and customized anomaly notification information is generated. In step 510, the customized anomaly notification information is communicated to the recipient computing device 124 associated with the new recipient to control the displaying of a graphical user interface to present the customized anomaly notification information specific to the new intended recipient associated with the new recipient entity node as a function of the initial association links. In some embodiments the customized anomaly notification information, which is recommended to be presented to a new recipient associated with the new recipient entity node, is identified as a function of the initial association links established and/or updated. As presented above, the steps 508 and 510 can be repeatedly applied over time to continue to provide relevant information. Further, the process 500 and/or one or more steps of the process 500 can be repeated as new entity nodes are incorporated. This process can similarly be applied with the incorporation of other types of new entity nodes and/or reinforcements can be enhanced through the existing links between other entity nodes based on an identification of a relationship between entity nodes. For example, reinforcement setup of new alerts, which are weakly related to a particular term or phase used in a search, can be surfaced to increase variety of alerts and to overcome the cold start problem.

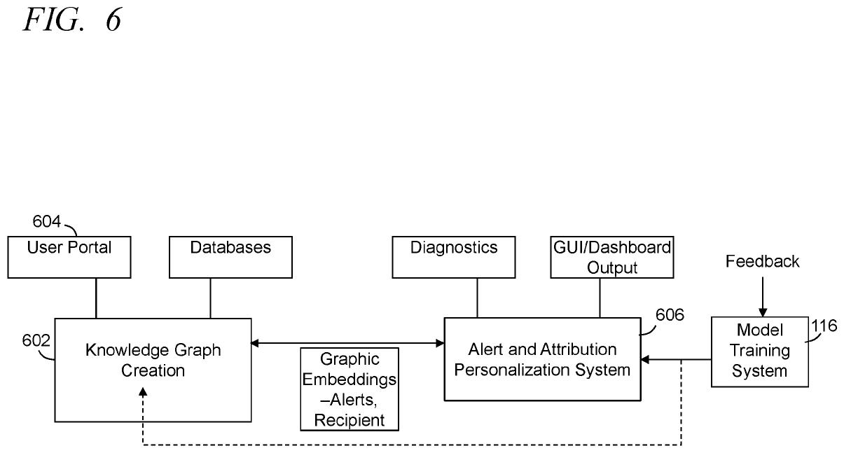

FIG. 6 shows a simplified block diagram functional representation of the retail product allocation control system 100 illustrating different functional aspects of the retail product allocation control system 100 and the interoperability of the functional aspects, in accordance with some embodiments. The retail product allocation control system 100 includes the knowledge graph system 602 that provides the functionality to create, update and maintain one or more knowledge graphs to enable recipients to obtain customized information, including at least customized anomaly notification information and provide control over retail product allocation and/or distribution based on the customized anomaly notification information. Some embodiments provide one or more user portals 604 enabling system control users to access and manage the system. In some embodiments, the knowledge graph system 602 implements some or all of the linkage mapping system 152. Further, one or more databases 106 are included and/or communicatively coupled with the system, as described above. Some embodiments include an alert and attribution personalization system 606 that functionally cooperates with the knowledge graph system 602, defines linking or embedding, provides for adjustments in levels of association corresponding to links, generates the outputs to control the graphical user interfaces rendered through recipient computing devices to display the respective customized anomaly notification information, and other such functionalities as described above and further below.

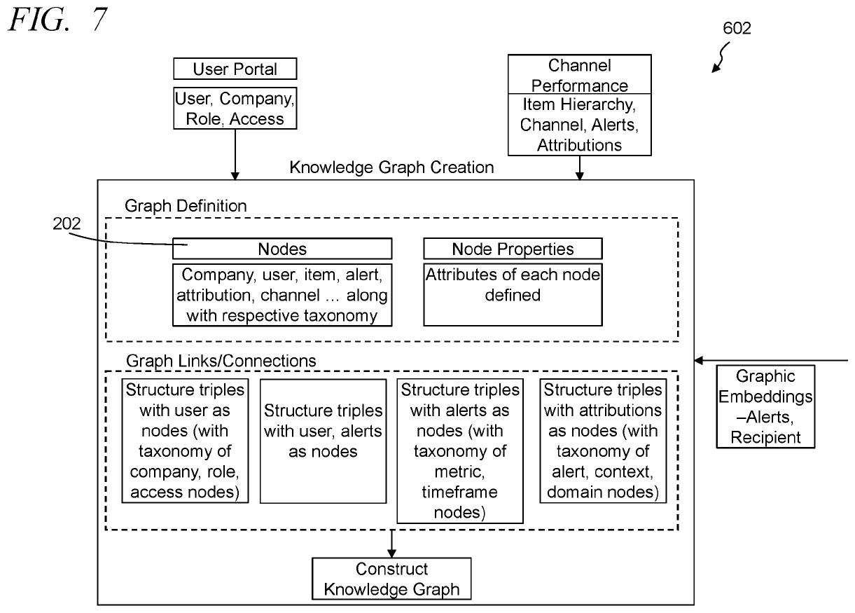

FIG. 6 shows a simplified block diagram functional representation of the retail product allocation control system 100 illustrating different functional aspects of the retail product allocation control system 100 and the interoperability of the functional aspects, in accordance with some embodiments. FIG. 7 shows a functional representation of the knowledge graph system 602 illustrating different functional aspects of the knowledge graph system 602 and the interoperability of the functional aspects, in accordance with some embodiments. The knowledge graph system 602 incorporates the entity nodes 202 and corresponding node properties. Further, the knowledge graph system 602 establishes the links within the knowledge graph.

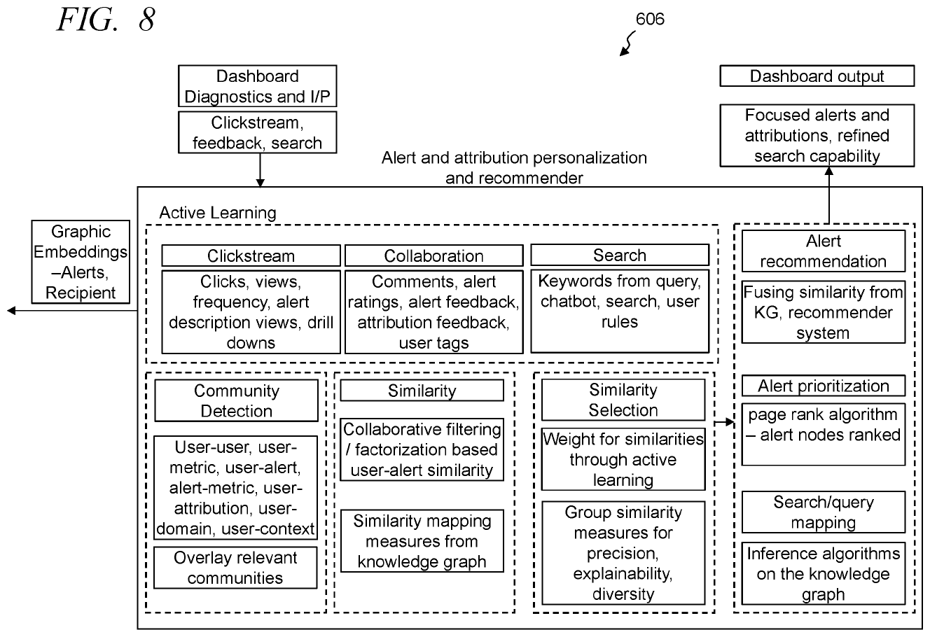

FIG. 8 shows a functional representation of the alert and attribution personalization system 606 illustrating different functional aspects of the alert and attribution personalization system 606 and the interoperability of the functional aspects, in accordance with some embodiments.

The model training system 116 includes one or more model training servers or managers, which are implemented through one or more computing systems, servers, computers, processor and/or other such systems communicatively coupled with one or more of the distributed communication networks 104, and are configured to build and/or train the machine learning models. In some implementations, the model training system 116 includes multiple sub-model training systems each associated with one or more of the different machine learning models.

The model training system further includes one or more training data databases storing the training data to be used in training the machine learning models of the product allocation control system 100. The training data databases can be local to the model training system, remote and accessible over one or more of the communication networks 104 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated and/or synthetic for the sake of training). Predictions are compared to actuals to ensure that the set of models are operating with a certain threshold confidence.

In some embodiments, one or more or all of the models described herein are trained by going through the same or similar analysis as described for the execution of the respective model. The models are trained with multiple sets of data with and/or without manual feedback to fine tune the results. Once the models provide consistent analysis with a given confidence level, the trained models are saved for use by the system in real time. Occasionally, the models can be re-trained or training can be supplemented with additional training data sets and with feedback during real time usage and/or after usage. In some embodiments, collected and/or received event data are transformed into one or more formats to facilitate training of the models and/or neural networks. In some embodiments, the models and/or neural networks may be trained in one or more stages. Each stage may output a particular trained model. In some embodiments, a trained model may be further trained in a subsequent stage based on another data set as input.

The above and below description includes descriptions of embodiments implementing and/or utilizing trained machine learning models and/or neural networks. In some embodiments, the neural network, machine learning models and/or machine learning algorithms may include, but are not limited to, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

As described above, the present embodiments in part enhance the identification of anomaly information, product information, product distribution information, demand information, other such retail information, and/or a combination of two or more of such information that is more relevant to a particular type of recipient and/or a particular recipient. Again, different potential recipients have different responsibilities, different goals, different KPIs, and/or are otherwise interested in different types of information (e.g., Sales/Account Manager (How are my brands selling vs goal? Which channels & markets are growing? How does execution & promotion look online & in-store, where do I improve?), Category Advisor (How do we optimize assortment? How to item, store & geographic drivers impact assortment and mod performance? What should the store mod/shelf layout look like? How & where should it vary?), Market Researcher/Marketing Manager (Are my brand's sales diverging from market/category trend? How are my brands/items doing as against my competitors? How are customer preferences affecting item sales growth/decline?), Retailer/Merchant (How are my suppliers selling vs goal? Which channels & markets are growing? How does execution & promotion look online & in-store, where do I improve?), Collaborative, Planning, Forecasting, and Replenishment (CPFR) Manager (Where am I in/out of stock? What's forecasted demand/PO? What's my OTIF look like?), Replenishment Manager (Where are my suppliers in/out of stock? How are my suppliers preparing for demand with upstream supply? How are my suppliers' OTIF scores?), etc.). Accordingly, the systems and methods enhance the distribution of information by identifying information that is expected to be most relevant to the type of recipient and/or the specific recipient. Still further, the systems and methods further improve performance over time through the continued retraining of machine learning models through feedback and updated training information, along with the use of the feedback to more accurately identify relevant information over time for the intended recipient. In part, some embodiments create and repeatedly update over time one or more retail knowledge graphs connecting users, collaborators, items, metrics, insights, attributions and/or other entities. The maintained knowledge graph(s), user community and user feedback and/or impressions are leveraged to generate personalized insights recommendations that typically includes and/or are based on respective customized anomaly notification information. The personalized insights can connect a user to their most relevant metrics and alerts with suitable attributions that are actionable by that user.

The cooperative application of the multiple sets of machine learning models and/or active-learning algorithms are used to generate and continually update and maintain the one or more retail knowledge graphs to connecting alerts, attributions and provide textualized insights to user personas. The systems and methods can deliver personalized insights and recommendations at the right hierarchy, at right time-frame, relevant metrics, key attributions to drive actionability, and/or other such enhancements. The machine learning models provide a scalable system to support different KPIs for different end-user personas and provide flexibility to support multiple feedback mechanisms (e.g., learning from user-defined rules, learning from user personas and preferences in retail hierarchy and metrics selection, learning from user actions and reactions in the graphical user interface, learning from user queries to the insights chat bots, learning from responses and tags between user personas, learning from text notifications and A/B testing of insights, learning from user engagement through clickstream data, etc.). Further, some embodiments enable user collaborations with similarity learning algorithms and provide suggestions on new exception rules and relevant insights. The systems and methods, in some implementations, additionally enable and/or support semantic insights search and query answering.

The one or more retail knowledge graphs support multiple functionalities, including but not limited to personalization of insights and actionable attributions, user collaboration, and supporting search querying. The personalization of insights and actionable attributions enable the delivery of personalized insights recommendations based on active, machine learning models and/or algorithms identifying and defining links to associate alerts+attributions+textualized insights to user personas. The machine learning mechanisms utilize intrinsic feedback through clickstream information and user attributes, feedback through collaboration, pointers through user rules, searches, chatbot conversations, A/B testing responses, and the like. The user enabled collaborations can be utilized by similar machine learning models and/or algorithms to provide suggestions on new exception rules & relevant insights. The support search and querying accurately capture user intent using semantic insights search, to provide fewer, more relevant results, and reduce blind spots.

Some embodiments support the building, completing and updating over time of the one or more knowledge graphs through one or more property graph data model with users and insights as nodes, with active learning using multiple feedback mechanisms from users, subsequent sales, subsequent modifications in distribution and/or other such sources of feedback, to extract attribute values of alerts and users (including values unseen in training data). Some embodiments comprise recommendation systems that implement and/or utilize community detection with respect to user-user relationships, user-metric relationships, user-product relationships, and/or other such relationships. Further, some embodiments evaluate and identify similarities, such as through latent factorization, collaborative filtering approaches and other such methods that are further enhanced through the knowledge graph embeddings. Still further, some embodiments apply weights of the similarity measures trained by active learning over time, at least from feedback. In some embodiments, page ranking and/or other such ranking is provided to prioritize the alert contexts, attribution domains, and/or other such information relative to one or more types of persona and/or particular recipients. Further, some embodiments apply one or more inference machine learning models and/or algorithms for search and query functionality. The knowledge graph establishes user-company-item-alert-attribution-other entity mapping. One or more of the links or edges, in some implementations, are uniformly weighted within relevant connections. The entity embeddings and relation embeddings are based on the known attributes and feedback and the relations from user inputs.

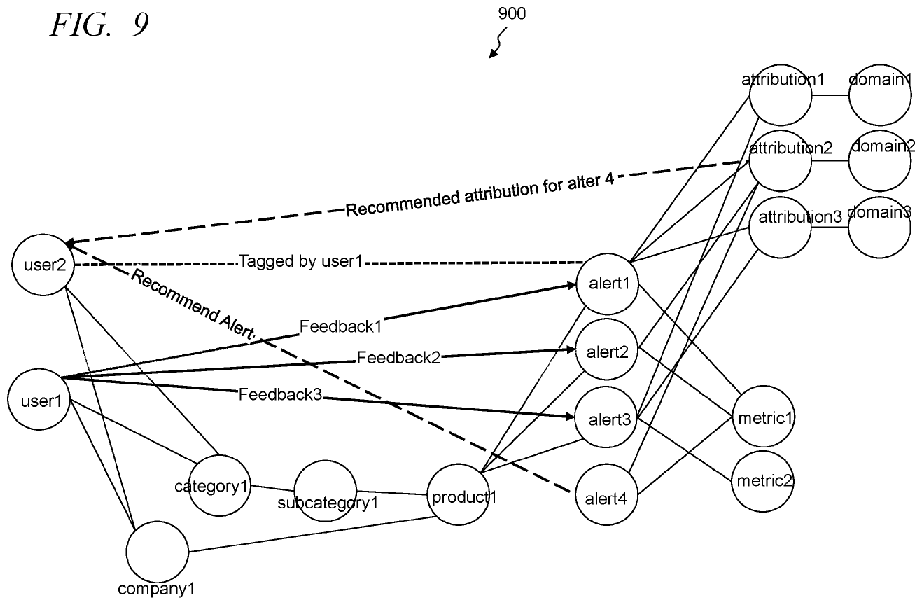

FIG. 9 illustrates an exemplary updating of links within an exemplary knowledge graph 900 in accordance with some embodiments. In this example, intended recipient 1 is associated with company 1 and is linked to product 1. Alerts may be created against product 1 that are surfaced for the intended recipient 1. Each alert is linked to one or more specific metrics, and each alert can have multiple attribution factors which represent different domains. In some implementations, one or more attributions can correspond to cause-effect factors, and/or relate to actions that may be taken in response to a cause. Feedback is received based on the intended recipient 1 interacting through the customized retail product performance information presented through the GUI, which can include for example the Alerts 1, 2 and 3. For example, the feedback may include clickstream feedback, such as explicit feedback in the form of a like/dislike or added comments. Through the machine learning models, the strength level of links or edges can be adjusted based on the feedback. For example, the strengths or levels of the links/edges between the intended recipient 1 and the alerts 1,2,3 and/or corresponding metrics 1,2 represented by the alerts and the attributions leading to it can be adjusted based on the feedback (e.g., increased in response to a like, decreased in response to a dislike, etc.).

Similarly, in this example, intended recipient 1 and intended recipient 2 may be linked and/or a level of association adjusted through machine learning community detection models. For example, intended recipient 1 may tag intended recipient 2 on alert 1 (e.g., identify one or more portions of the customized notification, and selects a graphically depicted, selectable option). When alert 1 has a strong linkage to metric 1 and attribution 1 and 2, their links or embeddings may be updated through active learning. For example, when intended recipient 2's linkage to intended recipient 1 becomes stronger, alert 4 may be predicted to have a strong linkage with intended recipient 2 and hence is recommended to link with the recipient entity associated with recipient 2. Correspondingly, attribution factor 2 may be strongly linked to alert 4 and is surfaced for intended recipient 2.

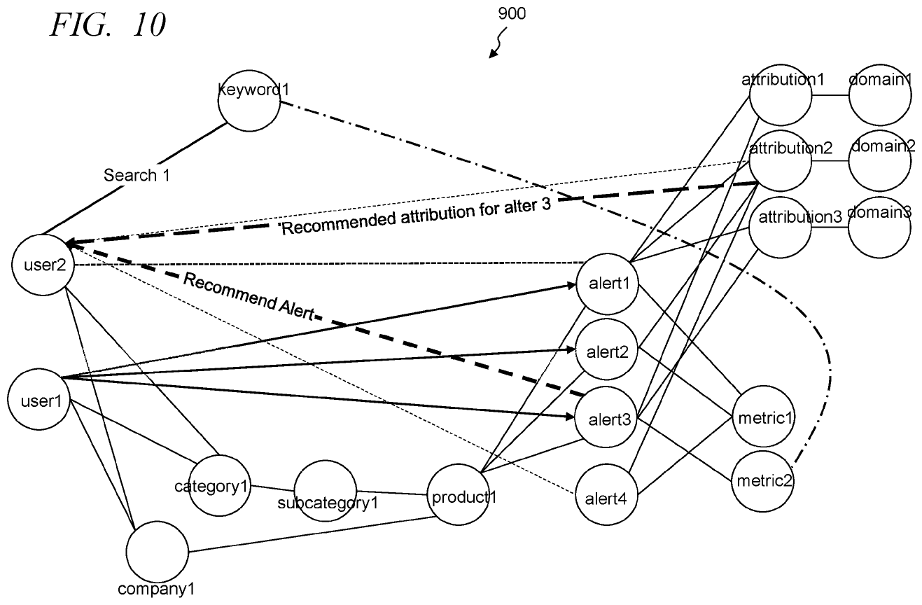

FIG. 10 illustrates an exemplary representation of updating of links within the knowledge graph 900 based on searching, in accordance with some embodiments. In this example, intended recipient 2 searches for keyword 1. Based on whether keyword is already embedded in the knowledge graph or is a new search, the linkages can be updated based on knowledge completion techniques. Since, in this example, the metric 2 gets a string linkage based on keyword 1, the relevant linkages predicted for user-to-alert and user-to-attributions can be alert 3 and attribution 2. Here, a reinforcement setup of new alerts which are weakly related to the keyword 1 can be surfaced to increase variety of alerts and to overcome cold start problem.

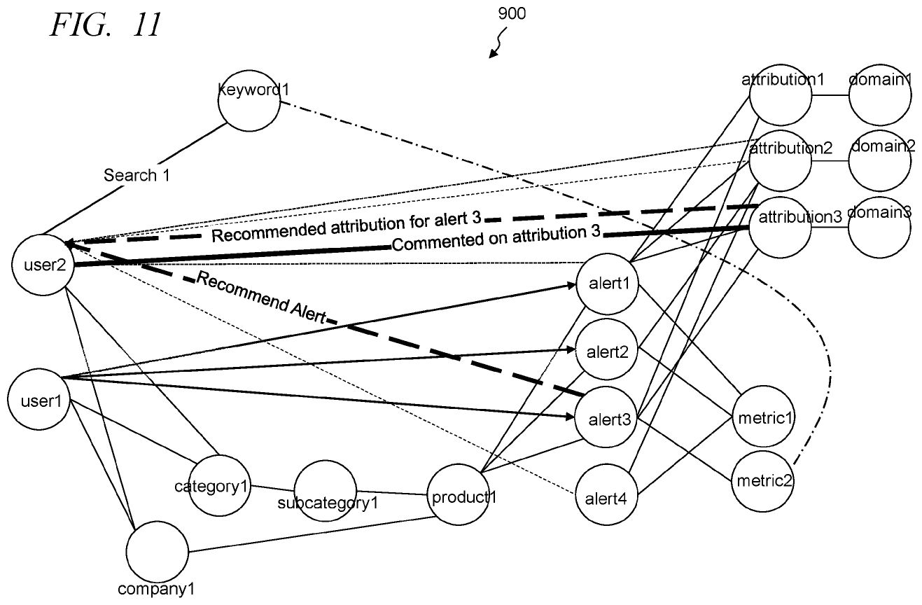

FIG. 11 illustrates an exemplary representation of updating of links within the knowledge graph 900 based on feedback, in accordance with some embodiments. In this example, the feedback includes a comment from intended recipient 2 relative to attribute 3. As a response to the recommended alert and attribution, the comments on attribution 3, based on the direction of the comment, the linkage between the alert and the attribution factor, the intended recipient and the attribution factor and its domain get updated, and correspondingly the embeddings of the graph can be updated. Further recommendations can be based on the new linkage strengths, considering the implicit inputs of the comment and like responses as an enhancement to the hybrid machine learning model of collaborative filtering. The new embeddings can also feature in as side information in factorization methods of a recommendation engine.

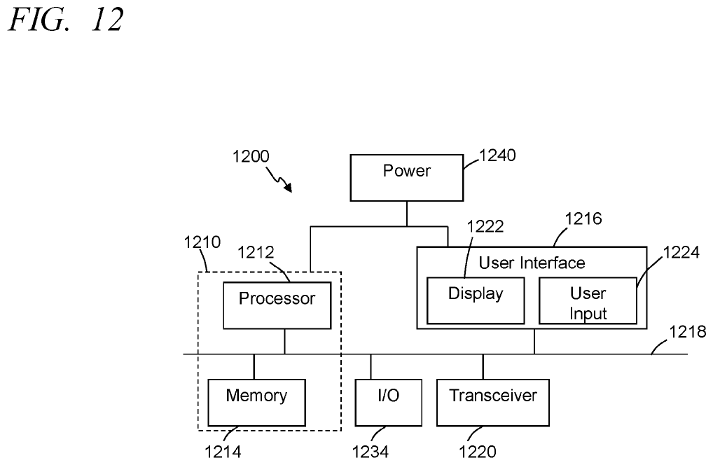

Further, the circuits, circuitry, systems, devices, processes, methods, techniques, functionality, services, servers, sources and the like described herein may be utilized, implemented and/or run on many different types of devices and/or systems. FIG. 12 illustrates an exemplary system 1200 that may be used for implementing any of the components, circuits, circuitry, systems, functionality, apparatuses, processes, or devices of the product allocation control system 100, the personalization recommendation system 112, linkage mapping system 152, the community detection system 156, similarity evaluation system 158, similarity weighting system 160, and/or other above or below mentioned systems or devices, or parts of such circuits, circuitry, functionality, systems, apparatuses, processes, or devices. However, the use of the system 1200 or any portion thereof is certainly not required.

By way of example, the system 1200 may comprise a control circuit or processor module 1212, memory 1214, and one or more communication links, paths, buses or the like 1218. Some embodiments may include one or more user interfaces 1216, and/or one or more internal and/or external power sources or supplies 1240. The control circuit 1212 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1212 can be part of control circuitry and/or a control system 1210, which may be implemented through one or more processors with access to one or more memory 1214 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1200 may be used to implement one or more of the above or below, or parts of, components, circuits, systems, processes and the like.

The user interface 1216 can allow a user to interact with the system 1200 and receive information through the system. In some instances, the user interface 1216 includes a display 1222 and/or one or more user inputs 1224, such as buttons, touch screen, track ball, keyboard, mouse, etc., which can be part of or wired or wirelessly coupled with the system 1200. Typically, the system 1200 further includes one or more communication interfaces, ports, transceivers 1220 and the like allowing the system 1200 to communicate over a communication bus, a distributed computer and/or communication network 104 (e.g., a local area network (LAN), the Internet, wide area network (WAN), etc.), communication link 1218, other networks or communication channels with other devices and/or other such communications or combination of two or more of such communication methods. Further the transceiver 1220 can be configured for wired, wireless, optical, fiber optical cable, satellite, or other such communication configurations or combinations of two or more of such communications.

Some embodiments include one or more input/output (I/O) ports 1234 that allow one or more devices to couple with the system 1200. The I/O ports can be substantially any relevant port or combinations of ports, such as but not limited to USB, Ethernet, or other such ports. The I/O interface 1234 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The system 1200 comprises an example of a control and/or processor-based system with the control circuit 1212. Again, the control circuit 1212 can be implemented through one or more processors, controllers, central processing units, logic, software and the like. Further, in some implementations the control circuit 1212 may provide multiprocessor functionality.

The memory 1214, which can be accessed by the control circuit 1212, typically includes one or more processor-readable and/or computer-readable media accessed by at least the control circuit 1212, and can include volatile and/or nonvolatile media, such as RAM, ROM, EEPROM, flash memory and/or other memory technology. Further, the memory 1214 is shown as internal to the control system 1210; however, the memory 1214 can be internal, external or a combination of internal and external memory. Similarly, some or all of the memory 1214 can be internal, external or a combination of internal and external memory of the control circuit 1212. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 104. The memory 1214 can store code, software, executables, scripts, data, content, lists, programming, programs, log or history data, user information, customer information, product information, and the like. While FIG. 12 illustrates the various components being coupled together via a bus, it is understood that the various components may actually be coupled to the control circuit and/or one or more other components directly.

As introduced above, some embodiments enhance the knowledge graph through community detection machine learning models. Such enhancement can include creating sub-graphs from the knowledge graph embeddings that overlay user-user relation embeddings, alert-attributes embeddings, attribution-domain similarity embeddings, and the like. Machine learning models for deriving similarity can be applied to identify recommendation and/or adjust levels of association relative to links. For example, some embodiments use hybrid models to get link predictions, that can use implicit feedback into collaborative filtering setting, with knowledge graph relation embeddings providing additional measures into factorization based recommendation engine. As a further example, the knowledge graph embedding can be enhanced through user touchpoints (e.g., clicks, frequency, views, drill-downs, and collaborations, searching, and/or other such feedback) by adding, removing and/or adjusting links based on the feedback. Some embodiments apply the active learning models with reinforcement setting to include variability in the alerts that are sent to recipients (e.g., surface new unseen alerts, capture touchpoints and learn from the feedback). Similarly, as new recipients, companies and/or other nodes are added to the knowledge graphs, cold-start problem are reduced or overcome through the reinforcement setting and the identification of similarities to enable auto-populating initial links with other nodes.

Some embodiments, in providing the customized anomaly notification information include one or more textual summary 304 textually explaining one or more alerts, their causes, forecasted deviation between forecasted trends of one or more business metrics for one or more products of a category of products relative to the intended goal, and/or other such information. For example, for an account manager, a textual summary may identify:
MOUTHWASH Subcategory has seen a sales decline of 13% week over week and has reached a 4 week minimum.
   BIS channel contributes to 94% of sales and has declined 12% week over week (4 week min)
   Sales decline trend shall lead to Quarterly sales target miss by 5%.

Some textual summaries identify what the anomaly is and/or a cause (e.g., “MOUTHWASH Subcategory has seen a sales decline of 13% week over week and has reached a 4 week minimum”), while further identifying where the anomaly is occurring (e.g., “BIS channel contributes to 94% of sales and has declined 12% week over week (4 week min)”). Still further, in some embodiments, the textual summary may provide a predictive forecasting (e.g., “Sales decline trend shall lead to Quarterly sales target miss by 5%”).

As another example, a category manager may receive a textual summary similar to:
KIDS ORAL CARE Category has seen a market share decline of 5% month over month.
   items within the subcategory have reduced by 5% from inventory stock-outs in 5% of stores for this category
   Competitor market share in this subcategory has increased by 5% in same period.
      This example identifies a reason for the alert (e.g., KIDS ORAL CARE Category has seen a market share decline of 5% month over month), with multiple potential causes and/or reasons for the alert (e.g., “items within the subcategory have reduced by 5% from inventory stock-outs in 5% of stores for this category”, and “Competitor market share in this subcategory has increased by 5% in same period”).

As a further example, a replenishment manager may receive a textual summary similar to:
ADULT TOOTHPASTE Subcategory has seen restricted sales.
   Arkansas region has 7% of stores with limited sales due to low inventory.
   Sales trend shows projected decline of 8% over the quarter.
      In this example, the reason for the alert is identified (e.g., “ADULT TOOTHPASTE Subcategory has seen restricted sales”), with a notification of where the anomaly(ies) is occurring (e.g., “Arkansas region has 7% of stores with limited sales due to low inventory”), and a forecast (e.g., “Sales trend shows projected decline of 8% over the quarter”).

The knowledge graph is utilized to identify relationships and enhance the information provided to users, which in turn can be used to control product sales, distribution, marketing, and/or other such activities. A traditional user-item knowledge graph is enhanced and extended in part to consider more entity mappings of user-alert and user-attribution, as well as applying extended levels or dimensions within the knowledge graph to establish previously undefined relationships that provide improved relations in identifying more relevant information (e.g., user-company, company-item, item-item hierarchy, item-alert, alert-attribution are the mappings being considered in the knowledge graph generation and/or updating). In some embodiments, an initial knowledge graph is established with a foundation of historical alerts utilizing sets of trained models. Knowledge graph embedding (KGE), through trained machine learning models (e.g., TransE, TransH, TransR and neural tensor network (NTN)) define distributed representations for entities and relations, sometimes referred to as entity embeddings and relation embeddings. The number of alert and attribution entities can increase and/or decrease over time (e.g., daily/weekly cadence), and links can similarly be modified over time thereby refreshing the embeddings and improving accuracy of relationships and the resulting identification of relevant information that can be used in controlling product distribution and improving sales.

For example, multiple recipients (e.g., Account Managers, Replenishment Managers, etc. can belong to Company CC1). Company CC1 supplies multiple products CI1-CI200 across various product categories. Alerts can be generated for any one of the products CI1-CI2100 based on whether there is an anomaly. Further, against the alerts some embodiments identify cause-effect attributions based on the linked mapping. In some embodiments, a retail can receive products from hundreds or thousands of suppliers/manufactures, in relation to tens of thousands to millions of different products or more. Alerts can be generated on a daily basis across different business metrics with the trained models using feedback to improve and enhance the linking association and a daily basis providing more accurate and improved information to enable more accurate and reliable control over product distribution and as a result improved health of business metrics such as sales. With the recipients' interactions against these generated alerts, knowledge graph embeddings can be retrained over time through active learning models. Further, the feedback can be used in cooperation with subsequent actions by recipients and/or subsequent product information (e.g., sales, demand, inventory levels, etc.) to retrain one or more models of the sets of machine learning models to continue to improve the results.

As described above, some embodiments utilize knowledge graph community detection, which in some implementations includes the creation of sub-graphs from the knowledge graph embeddings overlaying recipient-recipient relation embeddings, alert-attributes embeddings, attribution domain similarity embeddings and other such linking. Subgraphs are defined or carved out in some implementations the recipient dimension based on recipient similarity, recipient attributes and recipient usage metrics. Further, some embodiments group alert metrics, such as based on their attributes and the feedback. In some embodiments, the community detection can include simple hierarchical divisive community detection methods (e.g., recipient communities identifying and/or updating strong and weak linkages), and for alert and attribution linkages, some embodiments apply Louvain community detection, deep walk with Gaussian mixture model (GMM) based community detection, other such community detection, or a combination of two or more of such methods. As one non-limiting example, the application of the machine learning models may group an account manager AM1 of Company C1 who is responsible for product category XYZ with an account manager AM5 of Company C2 who is responsible for the products under same or similar categories. Using the linkages and feedback, the system can recommend based on alerts that AM1 prefers the same or similar attributes and/or alerts can be linked with AM5 resulting in relevant alerts for AM5 that are similar to or the same as those alerts provided to AM1. In some embodiments, similarity models and/or algorithms for Recommendations can be implemented using hybrid models for getting link predictions. Implicit feedback into collaborative filtering setting can be applied. Knowledge graph relation embeddings can further provide additional measures into factorization based recommendation engines.

Again, some embodiments identify new links and/or modify links using feedback. For example, additional relation embeddings can be identified and generated based on recipient touchpoints. Further, active learning and/or training of the sets of models enhance reinforcement setting can be applied, which in some instances provides variability in the alerts that are sent. This can result in surfacing new unseen alerts, capturing touchpoints and learning and/or modifying models from the feedback. Similarly, cold-start problems can be reduced or overcome through the reinforcement setting as new users, companies and the like are added to knowledge graphs. The solution enables the channel performance insights dashboard to be focused to each group of recipients' and/or individual recipient's area of relevance.

The knowledge graph is built and repeatedly and/or continuously updated over time with recipients and insights associated through entity nodes. The machine learning models provide active learning based on multiple feedback mechanisms from recipients to, in part, extract attribute values of alerts and recipients (including values unseen in training data). Further, the application of the sets of machine learning models provides recommendation systems through community detection with respect to user-user relationships, user-metric relationships, user-item relationships. Some embodiments utilize latent factorization and collaborative filtering approaches in identifying similarities that are enhanced and/or focused through the knowledge graph embeddings, with weights of the similarity measures trained by active machine learning models from feedback. Using the feedback and association, the system can provide page ranking to prioritize the alert contexts and attribution domains. Further, some embodiments apply inference machine learning models and/or algorithms based on intended recipient search and query.

Some embodiments provide systems to control the presentation of customize retail product performance information to respective individuals based on a continuously updated an enhanced, multi-level knowledge graph by applying multiple machine learning models. The enhanced, multi-level knowledge graph defines linked associations between nodes corresponding to intended recipients of the information, product hierarchies, alerts, attributes, metrics, and other relevant associations. The system includes a linkage mapping system, a personalization recommendation system and a community detection system. The linkage mapping system that defines and updates the multi-level linkings between entity nodes. The entity nodes comprise product source nodes associated with each of multiple different product sources providing products to one or more retailers, recipient nodes each associated with one of multiple intended recipient users that are each associated with a respective one of the product sources, product nodes each associated with a different retail product supplied to the one or more retailers, and alert nodes each associated with an anomaly alert corresponding to a category of products relative to one or more business metrics (e.g., sales, inventory, marketing, shipping, distribution, product placement, manufacturing, employees, equipment, etc.). The personalization recommendation system controls different display systems to control respective graphical user interfaces presenting different customized anomaly notification information specific to respective intended recipients of numerous different intended recipients as a function of the linkings associated with the respective intended recipient. The community detection system applies a set of machine learning community detection models to identify, based on feedback data from multiple intended recipients of the numerous different intended recipients each relative to one of the presented different customized anomaly notification information, additional relationships between two or more of the entity nodes, and cause the linkage mapping system to update the multi-level linkages to embed one or more additional association links between the two or more of the entity nodes based on the identified additional relationships. The personalization recommendation system is configured to control, based on the updated additional association links, a first graphical user interface to present first customized anomaly notification information specific to a first intended recipient, of the numerous different intended recipients, associated with a first recipient entity node of the two or more entity nodes based on a first additional association link, of the updated additional association links, of the first recipient entity node.

In some embodiments, provide systems to control customized retail product performance information presented to respective individuals, comprising: a linkage mapping system configured to define and update multi-level linkings within a knowledge graph between entity nodes, wherein the entity nodes comprise product source nodes each associated with one of multiple different product sources providing products to one or more retailers, recipient nodes each associated with one of multiple intended recipient users that are each associated with a respective one of the product sources, product nodes each associated with a different retail product supplied to the one or more retailers, and anomaly alert nodes each associated with an alert corresponding to a category of products relative to a business metric; a personalization recommendation system controlling different display systems to control respective graphical user interfaces presenting different customized anomaly notification information specific to respective intended recipients of numerous different intended recipients as a function of the linkings associated with the respective intended recipient; and a community detection system applying a set of machine learning community detection models to identify additional relationships between two or more of the entity nodes, based on feedback data from multiple intended recipients of the numerous different intended recipients each relative to one of the presented different customized anomaly notification information, and cause the linkage mapping system to update the multi-level linkages to embed one or more additional association links between the two or more of the entity nodes based on the identified additional relationships; wherein the personalization recommendation system is configured to control, based on the updated additional association links, a first graphical user interface to present first customized anomaly notification information specific to a first intended recipient, of the numerous different intended recipients, associated with a first recipient entity node of the two or more entity nodes based on a first additional association link, of the updated additional association links, of the first recipient entity node.

Some embodiments provide methods to control customized retail product performance information presented to respective individuals, comprising: defining and updating multi-level linkings within a knowledge graph between entity nodes comprising product source nodes each associated with one of multiple different product sources providing products to one or more retailers, recipient nodes each associated with one of multiple intended recipient users that are each associated with a respective one of the product sources, product nodes each associated with a different retail product supplied to the one or more retailers, and anomaly alert nodes each associated with an alert corresponding to a category of products relative to a business metric; controlling different display systems to control respective graphical user interfaces presenting different customized anomaly notification information specific to respective intended recipients of numerous different intended recipients as a function of the linkings associated with the respective intended recipient; applying a set of machine learning community detection models, and identifying additional relationships between two or more of the entity nodes, based on feedback data from multiple intended recipients of the numerous different intended recipients each relative to one of the presented different customized anomaly notification information; causing the linkage mapping system to update the multi-level linkages to embed one or more additional association links between the two or more of the entity nodes based on the identified additional relationships; and controlling, based on the updated additional association links, a first graphical user interface to present first customized anomaly notification information specific to a first intended recipient, of the numerous different intended recipients, associated with a first recipient entity node of the two or more entity nodes based on a first additional association link, of the updated additional association links, of the first recipient entity node.

Personalized insights can connect a user to their most relevant metric with suitable attributions that are actionable by that user. For example, the knowledge graphs can be utilized by the allocation systems and methods described in corresponding U.S. Provisional Application No. 63/389,251, filed Jul. 14, 2022, entitled Systems and Methods of Controlling Retail Product Allocation and Retail Market Variations based on Customized Insight, by Balasubramanian et al., with Attorney Docket No. 8842-154413-USPR_7059US01, which is incorporated herein by reference in its entirety.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system to control customized retail product performance information presented to respective individuals, comprising:
a linkage mapping system configured to define and update multi-level linkings within a knowledge graph between entity nodes, wherein the entity nodes comprise product source nodes each associated with one of multiple different product sources providing products to one or more retailers, recipient nodes each associated with one of multiple intended recipient users that are each associated with a respective one of the product sources, product nodes each associated with a different retail product supplied to the one or more retailers, and anomaly alert nodes each associated with an alert corresponding to a category of products relative to a business metric;
a personalization recommendation system controlling different display systems to control respective graphical user interfaces presenting different customized anomaly notification information specific to respective intended recipients of numerous different intended recipients as a function of the linkings associated with the respective intended recipient; and
a community detection system applying a set of machine learning community detection models to identify additional relationships between two or more of the entity nodes, based on feedback data from multiple intended recipients of the numerous different intended recipients each relative to one of the presented different customized anomaly notification information, and cause the linkage mapping system to update the multi-level linkings to embed one or more additional association links between the two or more of the entity nodes based on the identified additional relationships;
wherein the personalization recommendation system is configured to control, based on the updated additional association links, a first graphical user interface to present first customized anomaly notification information specific to a first intended recipient, of the numerous different intended recipients, associated with a first recipient entity node of the two or more entity nodes based on a first additional association link, of the updated additional association links, of the first recipient entity node.

2. The system of claim 1, wherein the community detection system in applying the community detection models is configured to evaluate touch points by each of the multiple intended recipients in considering the respective customized anomaly notification information, and identifying associations between two or more of the multiple intended recipients as a function of correlations between respective touch points.

3. The system of claim 1, wherein the community detection system is configured to:
obtain, through the first graphical user interface by the first intended recipient, feedback comprising a tagging to direct to a second intended recipient a portion of the first customized anomaly notification information corresponding to a first alert entity node that is associated with a second recipient entity node; and
apply one or more of the set of community detection models based on the tagging in identifying the additional relationships and cause, in updating the linkages, the linkage mapping system to update the multi-level linkings to increase a level of association of a first recipient-recipient link between a first recipient entity node associated with the first intended recipient and a second recipient entity node associated with the second intended recipient, embed a first recipient-alert link between the second recipient entity node and the first alert entity node, and increase a level of association of alert-attribute links between the first alert entity node and a set of attribute nodes previously associated with the first alert entity node.

4. The system of claim 3, wherein the community detection system, in applying the set of community detection models, is further configured to recommend embedding a recipient-alert link between the second recipient entity node and a second alert entity node in response to the increasing of the level of association of the first recipient-recipient link between the first recipient entity node and the second entity recipient node and based on a strength of a level of association of the first recipient-recipient link between the first recipient entity node and the second recipient entity node and based on a strength of a level of association of a second recipient-alert link between the first recipient entity node and the second alert entity node.

5. The system of claim 1, wherein the community detection system, in applying the set of machine learning community detection models, further causes updating of the linkages based on a search through the graphical user interface by the first intended recipient as feedback in response to identifications of links between nodes associated with search criteria.

6. The system of claim 1, further comprising:
a similarity evaluation system configured to apply a set of machine learning similarity models to pluralities of different recipient-alert links between different sets of recipient entity nodes and alert entity nodes in relation to the feedback comprising interaction by the first intended recipient with the first customized anomaly notification information, and identify relative similarity measures associated with each of the respective recipient entity node and the respective alert entity node in predicting potential additional linkages to associate with multiple other recipient entity nodes.

7. The system of claim 6, wherein the similarity evaluation system in applying the set of similarity models focuses factorization and filtering of associations between entity nodes as a function of embedded links between respective pairs of entity nodes.

8. The system of claim 6, further comprising:
a similarity weighting system configured to apply a set of machine learning weighting models relative to the similarity measures over time based on the feedback continuing to be received over time from the multiple intended recipient users to repeatedly modify weightings to identified similarity measures in selecting appropriate similarity measures relative to a particular one of the multiple intended recipient users in predicting the potential additional linkages to associate with the particular one of the multiple other recipient entity nodes.

9. The system of claim 1, wherein:
the linkage mapping system is configured to add a second recipient node in response to a new intended recipient being associated to receive personalized anomaly notification information; and
the community detection system, in applying one or more of the set of community detection models, is configured to identify that the second intended recipient has a threshold relationship with the first intended recipient, and cause the linkage mapping system, in response to adding the second recipient node and the identification of the threshold relationship with the first intended recipient, to update the multi-level linkings to embed multiple initial association links corresponding to a set of association links between the first recipient entity node and two or more other recipient entity nodes; and
wherein the personalization recommendation system controls, based on the initial association links, a second graphical user interface to present second customized anomaly notification information specific to the second intended recipient associated with the second recipient entity node as a function of the initial association links.

10. A method to control customized retail product performance information presented to respective individuals, comprising:
defining and updating multi-level linkings within a knowledge graph between entity nodes comprising product source nodes each associated with one of multiple different product sources providing products to one or more retailers, recipient nodes each associated with one of multiple intended recipient users that are each associated with a respective one of the product sources, product nodes each associated with a different retail product supplied to the one or more retailers, and anomaly alert nodes each associated with an alert corresponding to a category of products relative to a business metric;
controlling different display systems to control respective graphical user interfaces presenting different customized anomaly notification information specific to respective intended recipients of numerous different intended recipients as a function of the linkings associated with the respective intended recipient;
applying a set of machine learning community detection models, and identifying additional relationships between two or more of the entity nodes, based on feedback data from multiple intended recipients of the numerous different intended recipients each relative to one of the presented different customized anomaly notification information;
causing updating of the multi-level linkings to embed one or more additional association links between the two or more of the entity nodes based on the identified additional relationships; and
controlling, based on the updated additional association links, a first graphical user interface to present first customized anomaly notification information specific to a first intended recipient, of the numerous different intended recipients, associated with a first recipient entity node of the two or more entity nodes based on a first additional association link, of the updated additional association links, of the first recipient entity node.

11. The method of claim 10, wherein the identifying the additional relationships based on the feedback comprises:
evaluating, based on the application of the community detection models, touch points by each of the multiple intended recipients in considering the respective customized anomaly notification information, and
identifying associations between two or more of the multiple intended recipients as a function of correlations between respective touch points.

12. The method of claim 10, further comprising:
obtaining, through the first graphical user interface by the first intended recipient, the feedback comprising a tagging to direct to a second intended recipient a portion of the first customized anomaly notification information corresponding to a first alert entity node that is associated with a second recipient entity node; and
applying one or more of the set of community detection models based on the tagging in identifying the additional relationships, wherein the updating the linkages comprises: updating the multi-level linkings to increase a level of association of a first recipient-recipient link between a first recipient entity node associated with the first intended recipient and a second recipient entity node associated with the second intended recipient; embedding a first recipient-alert link between the second recipient entity node and the first alert entity node; and increasing a level of association of alert-attribute links between the first alert entity node and a set of attribute nodes previously associated with the first alert entity node.

13. The method of claim 12, further comprising:
recommending, based on the application of the set of community detection models, embedding a recipient-alert link between the second recipient entity node and a second alert entity node in response to the increasing of the level of association of the first recipient-recipient link between the first recipient entity node and the second entity recipient node and based on a strength of a level of association of the first recipient-recipient link between the first recipient entity node and the second recipient entity node and based on a strength of a level of association of a second recipient-alert link between the first recipient entity node and the second alert entity node.

14. The method of claim 10, further comprises:
causing, based on the application of the set of machine learning community detection models, updating of the linkages based on a search, through the graphical user interface, by the first intended recipient as feedback in response to identifications of links between nodes associated with search criteria.

15. The method of claim 10, further comprising:
applying a set of machine learning similarity models to pluralities of different recipient-alert links between different sets of recipient entity nodes and alert entity nodes in relation to the feedback comprising interaction by the first intended recipient with the first customized anomaly notification information; and
identifying relative similarity measures associated with each of the respective recipient entity node and the respective alert entity node in predicting potential additional linkages to associate with multiple other recipient entity nodes.

16. The method of claim 15, wherein the applying the set of similarity models focuses factorization and filtering of associations between entity nodes as a function of embedded links between respective pairs of entity nodes.

17. The method of claim 15, further comprising:
applying a set of machine learning weighting models relative to the similarity measures over time based on the feedback continuing to be received over time from the multiple intended recipient users to repeatedly modify weightings to identified similarity measures in selecting appropriate similarity measures relative to a particular one of the multiple intended recipient users in predicting the potential additional linkages to associate with the particular one of the multiple other recipient entity nodes.

18. The method of claim 10, further comprising:
adding a second recipient node in response to a new intended recipient being associated to receive personalized anomaly notification information;
identifying, based on the application of one or more of the set of community detection models, that the second intended recipient has a threshold relationship with the first intended recipient; and
updating, in response to adding the second recipient node and the identification of the threshold relationship with the first intended recipient, the multi-level linkings embedding multiple initial association links corresponding to a set of association links between the first recipient entity node and two or more other recipient entity nodes; and
controlling, based on the initial association links, a second graphical user interface to present second customized anomaly notification information specific to the second intended recipient associated with the second recipient entity node as a function of the initial association links.
